(19) United States
(12) Patent Application Publication
(10) Pub. No.: US 2006/0140272 A1
(43) Pub. Date: Jun. 29, 2006

(54) Wireless transmission of data signals in a bicycle, exercise equipment or the like

(76) Inventor: Edward M. Watson, Madison, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/315,653

(22) Filed: Dec. 22, 2005

Related U.S. Application Data
(60) Provisional application No. 60/639,102, filed on Dec. 23, 2004.

(51) Int. Cl. H04N 11/04

(52) U.S. Cl. 375/240.15

(57) ABSTRACT

An apparatus includes a frame having first and second spaced apart areas. A movable member is mounted adjacent the first area, and a sensor senses an operating characteristic of the movable member. A data receiving device is located in the vicinity of the second area of the frame. A first data signal transmission component is interconnected with the sensor, and receives data signals from the sensor and inputs the data signals to the frame. A second data signal transmission component is interconnected with the data receiving device, and receives data signals from the frame and transmits the data signals to the data receiving device. The data signals are transmitted though the frame from the first data signal transmission component to the second data signal transmission component. The apparatus may be a bicycle, and the movable member may be a bicycle wheel or pedal assembly. The apparatus may also be an item of exercise equipment, and the movable member may be a flywheel or a user input area of the exercise equipment.

### BACKGROUND AND SUMMARY

This invention relates to transmission of signals from one location to another, such as the transmission of sensing signals to a data receiving or display device in an application such as a bicycle or exercise equipment.

Transmission of data signals from one location to another, such as in a bicycle or in exercise equipment, is typically accomplished using either a wired or a wireless transmission arrangement. In a wired arrangement, a data signal from a device, such as a sensor for sensing one or more operating characteristics, is communicated to another device, such as an on-board computer or other data storage or processing device, using a wire that is connected between the two devices. This arrangement ensures reliable transmission of the data signals, but the use of a wire presents numerous drawbacks. For example, a wired arrangement involves installation of the wire, which must be restrained against movement at intermittent locations along its length, e.g. by use of cable ties, tape, etc. Such restraints can become dislodged during use, and must continually be maintained to insure that the wire does not interfere with operation of the bicycle or exercise equipment. In addition, the use of several sensors multiplies this problem, in that a wire must be installed for each sensor. The installation of wires also detracts from the aesthetics of the bicycle or exercise equipment.

Wireless data signal transmission involves use of a transmitter at one location, e.g. adjacent the sensor, which transmits a signal to a receiver at another location, e.g. adjacent the data processing or storage device. While this type of signal transmission is also satisfactory, it involves drawbacks in requiring separate components for receiving and transmitting the signal, which add to the cost and complexity of the system.

It is an object of the present invention to provide a system for transmitting signals from one location to another location on a frame or other support structure, without the use of wires and without the use of wireless transmission components. It is another object of the present invention to provide such a system for transmitting sensor signals relating to movement of a member that is movably mounted to, or adjacent, the frame or other support structure. Yet another object of the invention is to provide such a system which does not detract from the structural strength or integrity of the frame or other support structure, and does not interfere with movement of the member relative to the frame. Yet another object of the invention is to provide such a system which can be retroactively installed or utilized in combination with a frame or other support structure. A still further object of the invention is to provide such a system which is relatively simple in its components and installation, and which can be used to transmit a number of different types of signals from one location to another on the frame or other support structure.

In the present invention, the signals are transmitted from one location to another using the frame of the apparatus, which may be in the form of a bicycle or an item of exercise equipment.

In accordance with one aspect of the invention, an apparatus includes a frame having first and second spaced apart areas, a movable member mounted adjacent the first area of the frame, a sensor located in the vicinity of the first area of the frame for sensing an operating characteristic of the movable member, and a data receiving device located in the vicinity of the second area of the frame. A first data signal transmission component is interconnected with the sensor and associated with the first area of the frame, and is configured to receive data signals from the sensor and to input the data signals to the frame. A second data signal transmission component is interconnected with the data receiving device and associated with the second area of the frame, and is configured to receive data signals from the frame and to transmit the data signals to the data receiving device. The data signals are transmitted though the frame from the first data signal transmission component to the second data signal transmission component.

In one embodiment, the apparatus is in the form of a bicycle and the frame is the bicycle frame. The movable member is movably mounted to the bicycle frame, and the sensor and the data signal receiving device are carried by the bicycle. The data signal receiving device may include a visual output, and is positioned on the frame so that the visual output is visible to a user supported by the seat of the bicycle. The movable member may be a wheel of the bicycle, or may be the pedal assembly of the bicycle.

In another embodiment, the apparatus is in the form of an item of exercise equipment that includes a frame. The frame includes a user support area, and the data signal receiving device may includes a visual output that is positioned on the frame so that the visual output is visible to a user supported on the user support area of the frame.

The invention also contemplates a method of transmitting operating characteristic data signals in an apparatus having a moving member mounted adjacent a first area of a frame, a sensor for sensing one or more operating characteristics of the moving member, and a data signal receiving device mounted adjacent a second area of the frame. This aspect of the invention contemplates the act of transmitting operating characteristic data signals from the sensor through the frame to the data receiving device.

Another aspect of the invention involves a system for transmitting operating characteristic data signals in an apparatus having a moving member mounted adjacent a first area of a frame, a sensor for sensing one or more operating characteristics of the moving member, and a data signal receiving device mounted adjacent a second area of the frame. This aspect of the invention includes operating characteristic data signal input means between the sensor and the frame for inputting operating characteristic data signals to the frame, and operating characteristic data signal receiving means between the data receiving device and the frame for receiving operating characteristic data signals transmitted through the frame and supplying the operating characteristic data signals to the data signal receiving device. The operating characteristic data signal input means is in the form of a coupling arrangement between the sensor and the frame that inputs operating characteristic data signals to the frame. Similarly, the operating characteristic data signal receiving means is in the form of a coupling arrangement between the frame and the data signal receiving device that received operating characteristic data signals from the frame and supplies the data signals to the data signal receiving device.

Various other features, objects and advantages of the invention will be apparent from the following detailed description taken together with the drawings.

### BRIEF DESCRIPTION OF THE DRAWINGS

The drawings illustrate the best mode presently contemplated of carrying out the invention. In the drawings:

FIG. 1 is an elevation view of an apparatus, in the form of a bicycle, incorporating the data signal transmission arrangement of the present invention;

FIG. 2 is an enlarged partial elevation view of a portion of the bicycle of FIG. 1, with reference to line 2-2, showing a data signal input arrangement incorporated in the data signal transmission arrangement of the present invention;

FIG. 3 is a partial section view taken along line 3-3 of FIG. 2;

FIG. 4 is a partial elevation view similar to FIG. 3, illustrating an alternative embodiment of the data signal input arrangement;

FIG. 5 is a partial elevation view taken along line 5-5 of FIG. 4;

FIG. 6 is an enlarged partial elevation view of a portion of the bicycle of FIG. 1, with reference to line 6-6, showing a data signal receiving arrangement incorporated in the data signal transmission arrangement of the present invention;

FIG. 7 is a partial section view taken along line 7-7 of FIG. 6;

FIG. 8 is a partial elevation view similar to FIG. 7, illustrating an alternative embodiment of the data signal receiving arrangement;

FIG. 9 is an elevation view of an apparatus, in the form of an item of exercise equipment, incorporating the data signal transmission arrangement of the present invention;

FIG. 10 is a partial section view taken along line 10-10 of FIG. 9;

FIG. 11 is a partial elevation view with reference to line 11-11 of FIG. 10, showing a data signal input arrangement incorporated in the data signal transmission arrangement of the present invention;

FIG. 12 is a view similar to FIG. 11, illustrating an alternative embodiment of the data signal input arrangement;

FIG. 13 is a section view taken along line 13-13 of FIG. 12;

FIG. 14 is an enlarged partial elevation view of a portion of the item of exercise equipment of FIG. 9, with reference to line 14-14, showing a data signal receiving arrangement incorporated in the data signal transmission arrangement of the present invention;

FIG. 15 is partial section view taken along line 15-15 of FIG. 14;

FIG. 16 is a partial elevation view similar to FIG. 15, illustrating an alternative embodiment of the data signal receiving arrangement;

FIG. 17 is a partial section view taken along line 17-17 of FIG. 16;

FIG. 18 is a partial elevation view illustrating an alternative embodiment of a sensor and electrode used in the data signal transmission arrangement of the present invention; and

FIG. 19 is a partial section view taken along line 19-19 of FIG. 18.

### DETAILED DESCRIPTION

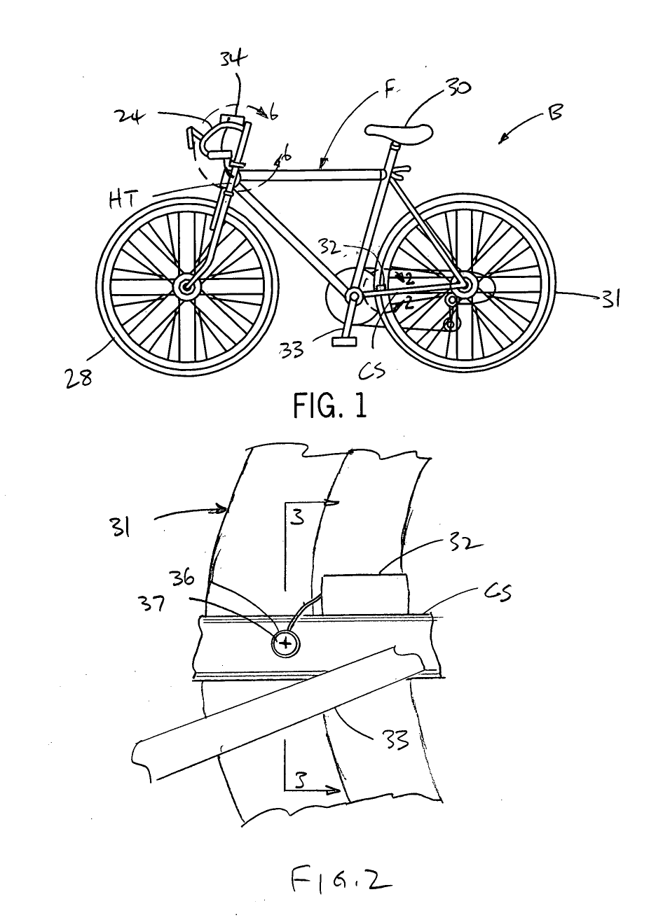

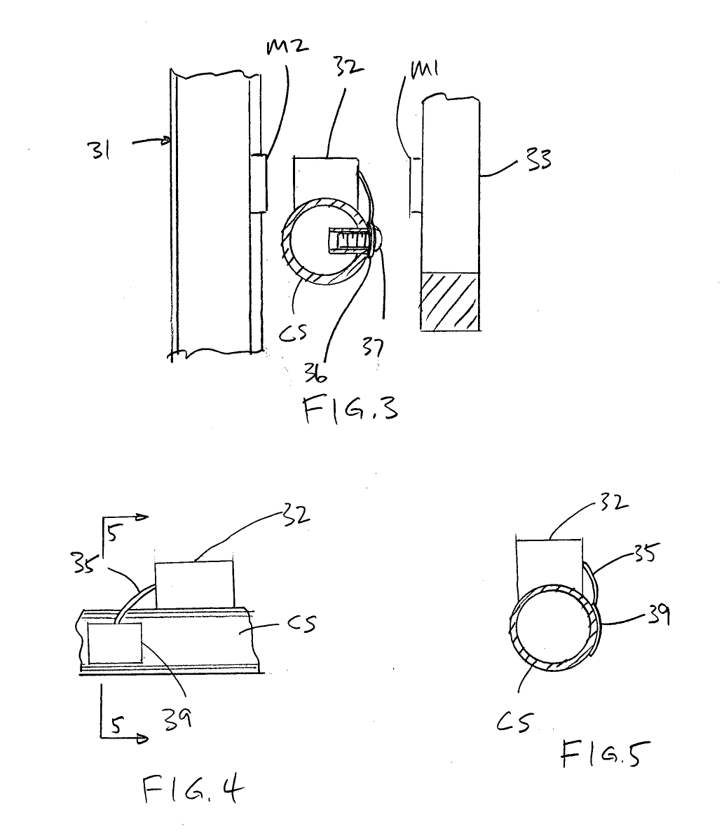

Referring to FIGS. 1-8, an example of a data signal transmission system in accordance with the present invention is illustrated in the form of a bicycle B having a frame F. Bicycle B includes a handlebar 24 and a seat 30, which support a user. A front wheel 28 and a rear wheel 31 are mounted to bicycle B in a manner as is known. Frame F of bicycle B may be constructed of a variety of materials, such as aluminum, steel, carbon fiber, or various combinations of such materials or any other satisfactory material that provides the required structural capability of mounting wheels 28, 31 and supporting a user.

In the illustrated application, a data processing or storage device, in the form of a CPU 34 which may include a data display, is mounted to handlebar 24 of bicycle B. It should be understood, however, that the data storage or processing device may take any satisfactory form and is not necessarily a CPU. It is also understood that the data storage or processing device may be mounted in any other location on bicycle B.

A sensor is mounted to bicycle B at a location remote from the data storage or processing device 34. In the illustrated embodiment, the sensor, shown at 32, is mounted to one of the lower chain stays CS of bicycle frame F. Representatively, the sensor 32 may be mounted so as to sense cadence (the rate or revolution of the bicycle pedal assembly, which includes pedal cranks 33), and/or the speed of revolution of rear wheel 31. In a representative embodiment, sensor 32 is a magnetically responsive member that outputs an electrical pulse in response to the presence of a magnet in the vicinity of the sensor 32. To sense cadence, a magnet M1 is mounted to one of pedal cranks 33 that passes in the vicinity of sensor 32 upon operation of the pedal assembly of bicycle B. Similarly, a magnet M2 is mounted to rear wheel 31, and is positioned so as to pass in the vicinity of sensor 32 upon rotation of rear wheel 31.

A wire 35 extends from sensor 32 and terminates in an electrode 36, which is engaged with the chain stay CS of bicycle frame F. In the illustrated embodiment, electrode 36 is secured to the chain stay CS of frame F using a fastener such as a screw 37. In a manner as is known, electrode 36 includes an opening, and the shank of screw 37 extends through the opening of electrode 36 for engagement with a receiver 38 that is embedded within, or otherwise secured to, the chain stay CS. The head of screw 37 engages electrode 36 with receiver 38, which is formed of an electrically conductive material. Receiver 38 is in intimate contact with the material of the chain stay CS, so that screw 37 and receiver 38 provide a conductive path between electrode 36 and chain stay CS.

In an alternative embodiment as shown in FIGS. 4 and 5, wire 35 is electrically connected to the chain stay CS of frame F by means of a conductive patch-type electrode 39. In a manner as is known, electrode 39 is bonded or otherwise conductively secured to the chain stay CS of frame F, to provide a conductive path between wire 35 and the frame chain stay CS. Yet another alternative involves an inductive coupling, in which a loop of wire is interconnected with wire 35 and encircles the chain stay CS of frame F to inductively input signals from wire 35 to the chain stay CS.

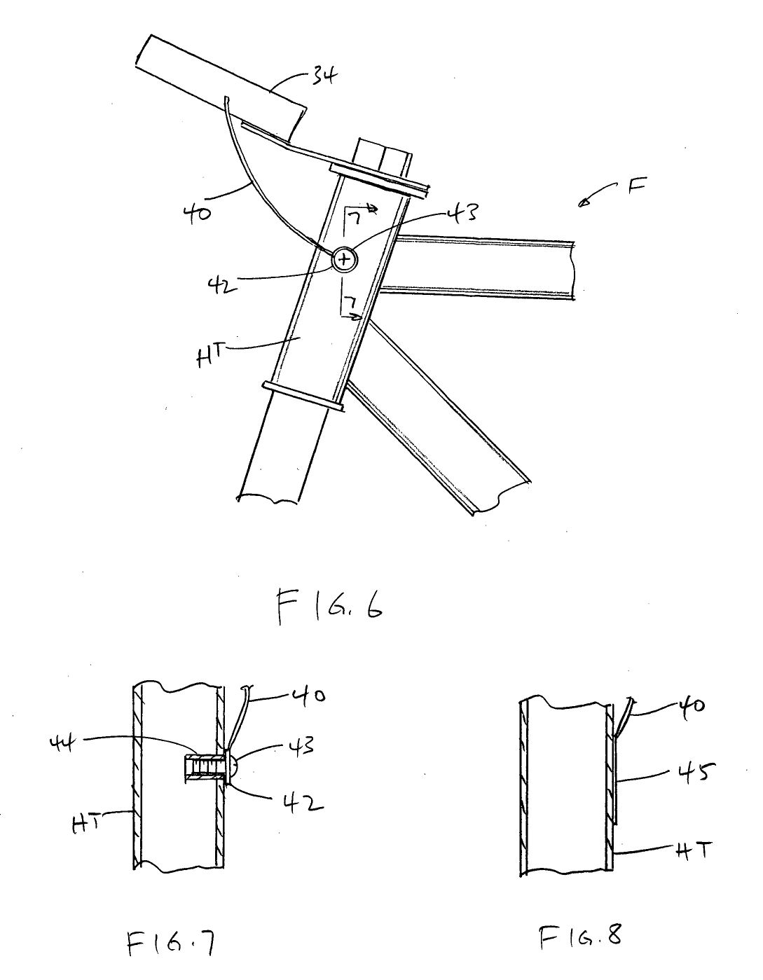

In a similar manner, and with reference to FIGS. 6-8, a wire 40 extends from CPU 34 and is connected to the head tube of bicycle frame F. Wire 40 terminates in an electrode 42, which is secured to the head tube HT of frame F using a fastener such as a screw 43. In a manner as is known, electrode 42 includes an opening, and the shank of screw 43 extends through the opening of electrode 42 for engagement with a receiver 44 that is embedded within, or otherwise secured to, the head tube HT. The head of screw 43 engages electrode 42 with receiver 44, which is formed of an electrically conductive material. Receiver 44 is in intimate contact with the material of head tube HT, so that screw 43 and receiver 44 provide a conductive path between electrode 42 and head tube HT.

In an alternative embodiment as shown in FIG. 8, wire 40 is electrically connected to the head tube HT of frame F by means of a conductive patch-type electrode 45. In a manner as is known, electrode 45 is bonded or otherwise conductively secured to the head tube HT of frame F, to provide a conductive path between wire 40 and the frame head tube HT. Yet another alternative involves an inductive coupling, in which a loop of wire is interconnected with wire 40 and encircles the head tube HT of frame F to inductively receive signals from head tube HT to input such signals to wire 40.

In operation, sensor 32 inputs a data signal to bicycle frame F at the electrically conductive connection between electrode 36 and frame chain stay CS. The data signal is transmitted through frame F to electrode 42, which is connected to frame head tube HT as noted above. The data signal is transmitted from electrode 42 through wire 40 to CPU 34. In a manner as is known, such input signals from sensor 32 are stored or otherwise processed by CPU 34, and relevant information from sensor 32 can then be displayed on the display of CPU 34 to the user in real-time manner, and/or stored for subsequent processing or display. The data signals from sensor 32 are transmitted from chain stay CS to head tube HT of frame F through the material of frame F. With this arrangement, frame F is the conductive medium through which the data signals are transferred from one location to another on frame F. The data signals are thus transmitted through a solid medium, i.e. the material of frame F, to provide the accuracy and reliability of a wired connection, without the need to install wires onto frame F other than the locations at which the input and output wires are secured to frame F.

Sensor 32 is shown as a combination-type sensor that senses the speed of rotation of wheel 31 as well as the cadence of operation of the bicycle pedal assembly. It should be understood that sensor 32 may sense cadence alone or wheel speed alone, and that two separate sensors could be used instead of one to measure the same operating parameters. In an arrangement such as this, each of the separate sensors has a signal input to the frame F in the same manner as described above. It is also contemplated that a sensor could be placed adjacent the bicycle front wheel 28 for detecting wheel speed. The sensor may also be in the form of a torque sensing device for use in calculating power expenditure by the user. The torque sensing device may be of the type that is incorporated in the hub of rear wheel 31, such as is available from Saris Cycling Group, Inc. of Madison, Wis. under its designation POWERTAP. Output signals from other types of torque or power sensing devices may be mounted to bicycle B for providing signals that can be inputted to frame F in the same manner as described above. Such devices may, for example, be associated with the bottom bracket of frame F or with the chain of bicycle B. In such applications, a lead wire or other conductor from the torque or power sensing device is electrically interconnected with frame F, as described above or in any other satisfactory manner, for inputting the data signal to frame F and to enable the data signal to be outputted from frame F for supply to a CPU or other processing, storage or display device.

The frame F allows a variety of communication types, from a simple transmitter/receiver pair to a complex multi-channel bidirectional communication system.

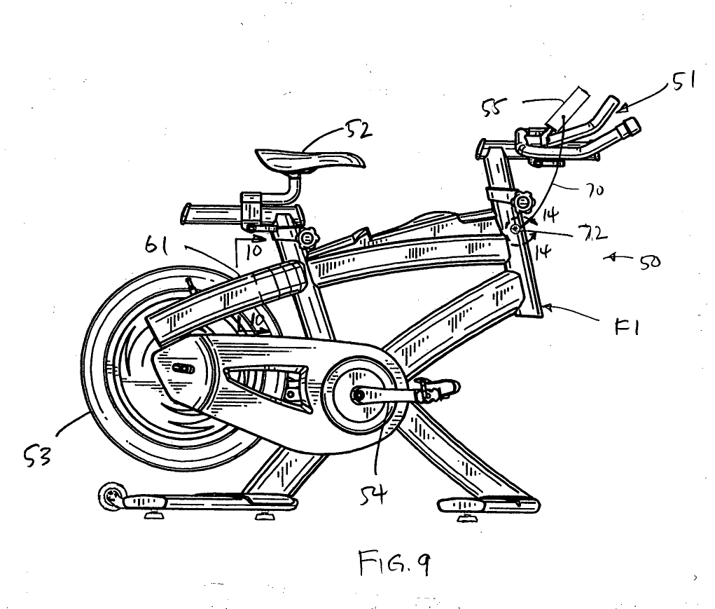

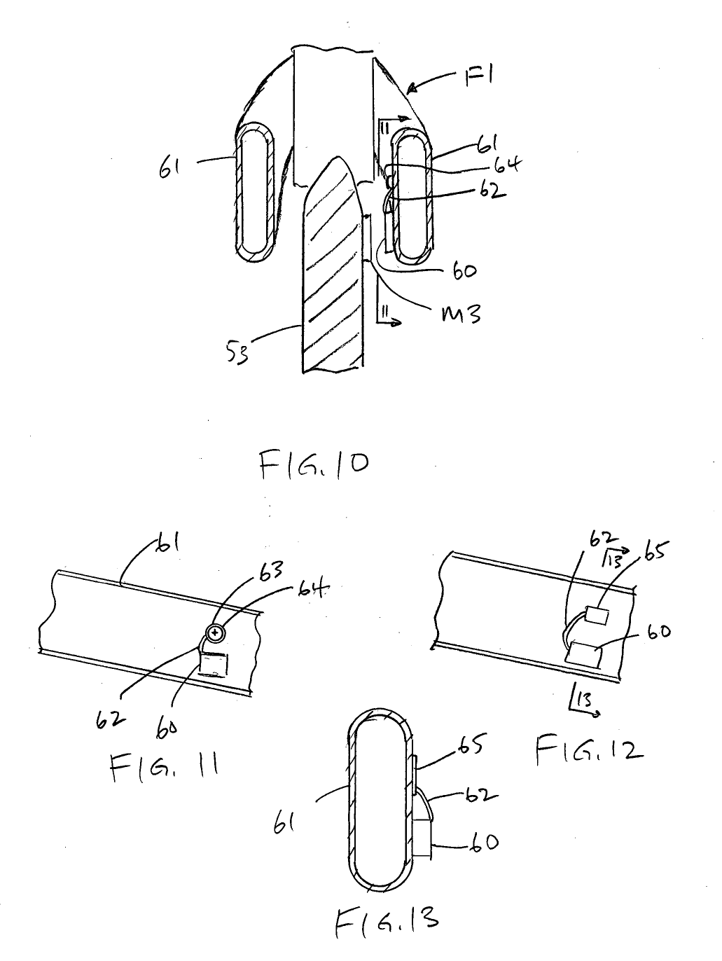

In an alternate embodiment as illustrated in FIGS. 9-17, signals can be transmitted from one location to another on an item of exercise equipment, such as an exercise cycle 50. Representatively, exercise cycle 50 may be such as is available from the Saris Cycling Group, Inc. of Madison, Wis. under its CycleOps brand (e.g. 300PT, 200E or 100). Exercise cycle 50 includes a frame F1 to which a handlebar assembly 51 is mounted. A seat 52 is supported by frame F1 rearwardly of handlebar assembly 51, and a flywheel 53 is rotatably mounted to frame F1. A pedal assembly including a pair of pedal crank arms 54 is rotatably supported by frame F1, and is used to impart rotation to flywheel 53, in a manner as is known, through a chain or other satisfactory drive mechanism. A data processing or storage device, in the form of a CPU 55 which may include a data display, is mounted to handlebar 51 of exercise cycle 50. It should be understood, however, that the data storage or processing device may take any satisfactory form and is not necessarily a CPU. It is also understood that the data storage or processing device may be mounted in any other location on exercise cycle 50.

Referring to FIG. 10, a sensor 60 is mounted to frame F1 of exercise cycle 50, such as to one of a pair of rearwardly extending support fork members 61 forming a part of frame F1. Representatively, sensor 60 may be of the type that senses the speed of rotation of flywheel 53. For example, as noted above with respect to sensor 32, sensor 60 may be in the form of a magnetically responsive sensor that outputs an electrical pulse in response to the presence of a magnet in the vicinity of the sensor 60. To sense the speed of rotation of flywheel 53, a magnet M3 is mounted to the surface of flywheel 53 that passes adjacent sensor 60 upon rotation of flywheel 53. In addition, a cadence sensor, similar to that described previously with respect to sensor 32, may be mounted to any satisfactory area of frame F adjacent to which one of the pedal cranks 54 passes during operation of the pedal assembly, to sense cadence.

A wire 62 extends from sensor 60 and terminates in an electrode 63, which is engaged with the frame fork member 61. As noted above, electrode 63 may be engaged with fork member 61 using a fastener such as a screw 64. In the same manner as described above with respect to wire 35, electrode 36 and screw 37, screw 64 and an associated receiver engaged with fork member 61 function to provide a conductive path between electrode 63 and frame member 61. In an alternative embodiment as illustrated in FIG. 12, wire 62 is electrically connected to frame member 61 of frame F1 by means of a conductive patch-type electrode 65, which is bonded or otherwise conductively secured to frame member 61 of frame F1 to establish a conductive path between wire 62 and fork member 61. Again, an inductive coupling may also be provided between frame member 61 and wire 62, by means of a loop of wire that is interconnected with wire 62 and encircles frame member 61 of frame F to inductively input signals from wire 62 to frame member 61.

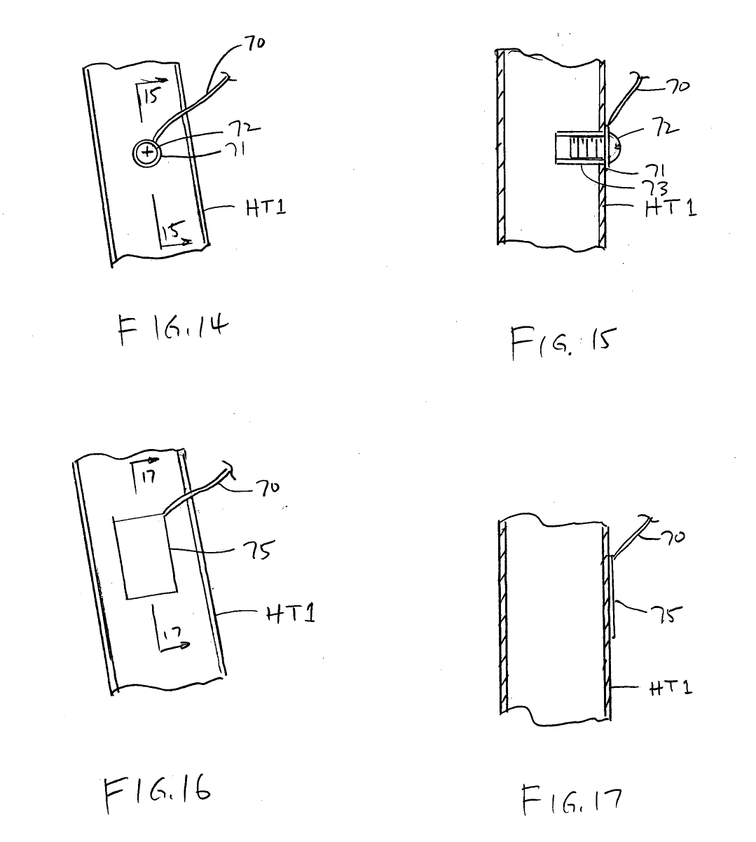

In a similar manner, and with reference to FIGS. 14 and 15, a wire 70 extends from CPU 55 and is connected to the head tube of cycle frame F1. Wire 70 terminates in an electrode 71, which is secured to the head tube HT1 of frame F1 using a fastener such as a screw 72. In a manner as is known, electrode 71 includes an opening, and the shank of screw 72 extends through the opening of electrode 71 for engagement with a receiver 73 that is embedded within, or otherwise secured to, the head tube HT1. The head of screw 72 engages electrode 71 with receiver 73, which is formed of an electrically conductive material. Receiver 73 is in intimate contact with the material of head tube HT1, so that screw 72 and receiver 73 provide a conductive path between electrode 71 and head tube HT1.

In an alternative embodiment as shown in FIGS. 16 and 17, wire 70 is electrically connected to the head tube HT1 of frame F1 by means of a conductive patch-type electrode 75. In a manner as is known, electrode 75 is bonded or otherwise conductively secured to the head tube HT1 of frame F1, to provide a conductive path between wire 70 and the frame head tube HT1. Yet another alternative involves an inductive coupling, in which a loop of wire is interconnected with wire 70 and encircles the head tube HT1 of frame F1 to inductively receive signals from head tube HT1 to input such signals to wire 70.

In operation, sensor 60 inputs a data signal to frame F1 at the electrically conductive connection between electrode 64 and fork member 61. The data signal is transmitted through frame F1 to electrode 71, which is connected to frame head tube HT1 as noted above. The data signal is transmitted from electrode 71 through wire 70 to CPU 55. In a manner as is known, such input signals from sensor 60 are stored or otherwise processed by CPU 55, and relevant information from sensor 60 can then be displayed on the display of CPU 55 to the user in a real-time manner, and/or stored for subsequent processing or display. The data signals from sensor 60 are transmitted from fork member 61 to head tube HT1 of frame F1 through the material of frame F1. With this arrangement, frame F1 is the conductive medium through which the data signals are transferred from one location to another on frame F1. The data signals are thus transmitted through a solid medium, i.e. the material of frame F1, to provide the accuracy and reliability of a wired connection, without the need to install wires onto frame F other than the locations at which the input and output wires are secured to frame F1.

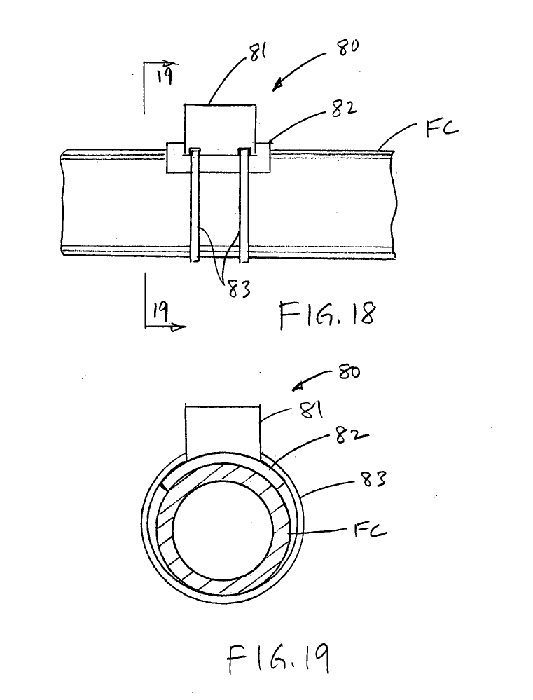

Sensor 60 is shown as a sensor that senses the speed of rotation of flywheel 53. It is understood that another similar sensor and signal input may be provided for the cadence of operation of the bicycle pedal assembly, or that speed and cadence information could be sensed and input using a combination sensor as described above. Also, as noted above, the sensor may also be in the form of a torque sensing device for use in calculating power expenditure by the user. The torque sensing device may be of the type that is incorporated in the hub of flywheel 53, such as is available from Saris Cycling Group, Inc. of Madison, Wis. under its designation POWERTAP (incorporated in the CycleOps 300 PT model). Output signals from other types of torque or power sensing devices may be mounted to cycle 50 for providing signals that can be inputted to frame F1 in the same manner as described above. Such devices may, for example, be associated with the bottom bracket of frame F1 or with the chain of cycle 50. In such applications, a lead wire or other conductor from the torque or power sensing device is electrically interconnected with frame F1, as described above or in any other satisfactory manner, for inputting the data signal to frame F1 and to enable the data signal to be outputted from frame F1 for supply to a CPU or other processing, storage or display device. FIGS. 18 and 19 illustrate an alternative embodiment of a combination sensing/input member 80 for use in the data signal transmission arrangement of the present invention. In this embodiment, the sensing components of sensing/input member 80 are contained within a housing 81. A conductive base 82 underlies housing 82. Base 82 is formed of an electrically conductive material, which preferably has flexible or resilient properties. Representatively, base 82 may be formed of a conductive rubber material, although it is understood that any other satisfactory conductive and flexible material may be employed. Housing 81 and base 82 may be formed in a co-molding operation, such that base 82 and housing 81 form a water-tight enclosure within which the sensing components of sensing/input member 80 are contained. In this embodiment, the sensing components of sensing/input member 80 are electrically connected to base 82, which in turn is in intimate contact with a frame component, shown at FC, that forms a part of the frame of the apparatus in connection with which sensing/input member 80 is used. For example, and without limitation, frame component FC may be a part of area of bicycle frame F or exercise cycle frame F1, or the frame of any other apparatus in connection with which the data signal transmission arrangement of the present invention is used. In this embodiment, the signals from the sensing components of sensing/input member 80 are transmitted to frame component FC through base 82, which eliminates the need for an exposed wire as in the previously described embodiments. The flexible nature of base 82 conforms to the contour of the frame of the apparatus, and enable sensing/input member 80 to be mounted to any area of the frame. Sensing/input member 80 may be secured to the frame in any satisfactory manner, such as by one or more cable ties 83, or by means of straps, fasteners, etc.

While the invention has been shown and described in connection with certain embodiments, it is understood that various alternatives and embodiments are contemplated as being within the scope of the present invention. For example, and without limitation, the signal communication system of the present invention may be used in other types of exercised devices such as a treadmill, elliptical exerciser, swim exerciser, rowing machine, ski machine, etc. The invention may also be used in combination with a motor-driven device such as a motorcycle, personal transporter, scooter, etc. Any type of data signal may be transmitted through the frame using the data signal transmission system of the present invention. In all cases, a signal indicative of a sensed characteristic or condition of a movable member is inputted into the frame of the device, and transmitted through the frame to another location on the device for collection, processing, display and/or storage of the data represented by the signal.

While the invention has been shown and described in the context of rotating members that are mounted to the frame, it is also understood that the data signal transmission system of the invention may also be incorporated in a system in which the movable member is supported adjacent to or in the vicinity of the frame, and is not necessarily mounted to the frame.

Various alternatives and embodiments are contemplated as being within the scope of the following claims particularly pointing out and distinctly claiming the subject matter regarded as the invention.

I claim:

1. An apparatus, comprising:
a frame having first and second spaced apart areas;
a movable member mounted adjacent the first area of the frame;
a sensor for sensing an operating characteristic of the movable member, wherein the sensor is located in the vicinity of the first area of the frame;
a data receiving device located in the vicinity of the second area of the frame;
a first data signal transmission component interconnected with the sensor and associated with the first area of the frame, wherein the first data signal transmission component is configured to receive data signals from the sensor and to input the data signals to the frame; and
a second data signal transmission component interconnected with the data receiving device and associated with the second area of the frame, wherein the second data signal transmission component is configured to receive data signals from the frame and to transmit the data signals to the data receiving device;
wherein the data signals are transmitted though the frame from the first data signal transmission component to the second data signal transmission component.

2. The apparatus of claim 1, wherein the apparatus comprises a bicycle and the frame comprises a bicycle frame, wherein the movable member is movably mounted to the bicycle frame, and wherein the sensor and the data signal receiving device are carried by the bicycle.

3. The apparatus of claim 2, wherein the data signal receiving device includes a visual output and is positioned on the frame so that the visual output is visible to a user supported by a seat interconnected with the bicycle frame.

4. The apparatus of claim 3, wherein the movable member comprises a bicycle wheel.

5. The apparatus of claim 3, wherein the movable member comprises a pedal assembly.

6. The apparatus of claim 1, wherein the apparatus comprises an item of exercise equipment and the frame comprises an exercise equipment frame.

7. The apparatus of claim 6, wherein the frame includes a user support area and wherein the data signal receiving device includes a visual output and is positioned on the frame so that the visual output is visible to a user supported on the user support area of the frame.

8. A method of transmitting operating characteristic data signals in an apparatus having a moving member mounted adjacent a first area of a frame, a sensor for sensing one or more operating characteristics of the moving member, and a data signal receiving device mounted adjacent a second area of the frame, comprising the act of transmitting operating characteristic data signals from the sensor through the frame to the data receiving device.

9. The method of claim 8, including the act of mounting the data signal receiving device in the vicinity of a user support area that comprises the second area of the frame.

10. The method of claim 9, including the act of providing the data signal receiving device with a visual display.

11. The method of claim 10, including the act of using an inductive coupling arrangement between the frame and one or both of the sensor and the data signal receiving device for supplying or receiving operating characteristic data signals to or from the frame.

12. The method of claim 10, including the act of using a capacitive coupling arrangement between the frame and one or both of the sensor and the data signal receiving device for supplying or receiving operating characteristic data signals to or from the frame.

13. The method of claim 10, including the steps of mounting the sensor and the data signal receiving device to first and second areas, respectively, of a bicycle frame.

14. The method of claim 10, including the steps of mounting the sensor and the data signal receiving device to first and second areas, respectively, of an exercise equipment frame.

15. A system for transmitting operating characteristic data signals in an apparatus having a moving member mounted adjacent a first area of a frame, a sensor for sensing one or more operating characteristics of the moving member, and a data signal receiving device mounted adjacent a second area of the frame, comprising:
operating characteristic data signal input means between the sensor and the frame for inputting operating characteristic data signals to the frame; and
operating characteristic data signal receiving means between the data receiving device and the frame for receiving operating characteristic data signals transmitted through the frame and supplying the operating characteristic data signals to the data signal receiving device.

16. The system of claim 15, wherein the operating characteristic data signal input means comprises an inductive coupling arrangement between the sensor and the frame.

17. The system of claim 15, wherein the operating characteristic data signal input means comprises a capacitive coupling arrangement between the sensor and the frame.

18. The system of claim 15, wherein the frame comprises a bicycle frame having a user support area, and wherein the data signal receiving device includes a visual display and the second area of the frame is situated so that the visual display of the data signal receiving device is visible to a user from the user support area of the bicycle frame.

19. The system of claim 15, wherein the frame comprises an exercise equipment frame having a user support area, and wherein the data signal receiving device includes a visual display and the second area of the frame is situated so that the visual display of the data signal receiving device is visible to a user from the user support area of the exercise equipment frame.
